(19) United States
(12) Patent Application Publication
(10) Pub. No.: US 2026/0228263 A1
(43) Pub. Date: Aug. 6, 2026

(54) PERSONALIZED PRIVACY PRESERVING LLM

(71) Applicant: InterDigital Patent Holdings, Inc., Wilmington, DE (US)

(72) Inventors: Satyavrat Wagle, West Lafayette, IN (US); John Kaewell, Jamison, PA (US); Shahab Hamidi-Rad, Sunnyvale, CA (US)

(73) Assignee: InterDigital Patent Holdings, Inc., Wilmington, DE (US)

(21) Appl. No.: 19/046,188

(22) Filed: Feb. 5, 2025

(51) Int. Cl. G06F 16/334; G06F 40/284

(52) U.S. Cl. CPC G06F 16/3347; G06F 40/284

(57) ABSTRACT

An apparatus may receive a query from a wireless transmit/receive unit (WTRU). The apparatus may identify at least one contextual data embedding vector that is relevant to at least one portion of an embedded vector associated with the query based on a criteria. The apparatus may input the query and/or portions of the query and/or the at least one contextual data embedding vector, based on the criteria, to a large language model (LLM). The at least one contextual data embedding may be incorporated with the query based on the criteria. The apparatus may receive a contextualized response to the query from the LLM based on the at least one contextual data incorporated with the query, based on the criteria. The apparatus may transmit the contextualized response via a (e.g., secure) network to the WTRU.

### BACKGROUND

A large language model (LLM) may be a type of artificial intelligence (Al) that uses machine learning (ML) to process natural language. Often, these LLMs process text that is input from a user in the absence of other relevant information. Additionally, in order for users to implement these LLMs, the user request or textual input and/or response may be transmitted over one or more networks, which may lack a desired level of security.

### SUMMARY

Embodiments described herein may include collecting, embedding, and/or storing multi-modal context information that may be implemented by a model to provide responses to user requests. User queries may be mapped with relevant context information. Queries may be augmented with the mapped contextual information, such as contextual embeddings, before feeding them to the large language model (LLM) or other models.

An apparatus may receive a query from a wireless transmit/receive unit (WTRU). The query may include a textual and/or audio query for information in a response. The apparatus may identify contextual data relevant to at least a portion of the query. For example, the apparatus may identify at least one contextual data embedding vector that is relevant to the at least one portion of an embedded vector associated with the query based on a criteria. The apparatus may input the query (e.g., and/or portions of the query) and/or the at least one contextual data embedding vector, based on the criteria, to a large language model (LLM). The LLM may be trained on sample queries and/or contextual data embedding vectors identified as relevant to the received query. The at least one contextual data embedding may be incorporated with the query based on the criteria. For example, the at least one contextual data embedded vector incorporated with the query and/or portions of the query may include the at least one contextual data embedded vector appended as embeddings and/or tokens to the query and/or portions of the query based on the criteria. The apparatus may receive a contextualized response to the query from the LLM based on the at least one contextual data embedded vector incorporated with the query, based on the criteria. The apparatus may transmit the contextualized response via a (e.g., secure, local) network to the WTRU.

The apparatus may receive, at an embedding module, contextual data related to potential queries from a user for information at an embedding module. The embedding module may convert each unit of information into a vector in a high-dimensional embedding space. The contextual data may include at least one of a textual data, audio data, image data, and/or video data. The embedding module may be trained to receive the contextual data and/or may generate different contextual data embedding vectors each including a vector of values configured to identify semantic relationships between different contextual data via spatial relationships in a spatial domain. The spatial relationships between different contextual data (e.g., between decomposed embedded vectors of a query and contextual data embedded vectors in an embedded datastore) may be indicated via distances and/or angles. For example, the embedding module may extract meaning(s) (e.g., semantics) of each piece of information. The apparatus may store the contextual data embedding vectors in an embedded datastore.

The apparatus may decompose, at a query processing module (QPM), the query into a set of vectorized embeddings. The QPM may take as input the user in text format and may output a set of vectorized embeddings. The vectorized embeddings may be compatible with the contextualized data embedded vectors in the embedded datastore. The set of vectorized embeddings may include the embedded vector. The QPM may decompose the query into the set of embedded vectors such that each embedded vector included in the set of embedded vectors is compatible with each contextual data embedded vector. For example, if the QPM and the embedding module both use the embedding layers of the LLM, the each embedded vector included in the set of embedded vectors may be compatible with each contextual data embedded vector. An information mapping module (IM) may map the set of embedded vectors to the contextual data embedded vectors such that the set of embedded vectors of the query is compatible with the contextual data embedded vectors. For example, if the QPM uses embedded vectors different from the embedding module, the IM may map the set of embedded vectors to the contextual data vectors such that the set of embedded vectors of the query is compatible with the contextual data embedded vectors.

The apparatus may calculate, at the IM, based on criteria, relevance of each embedded vector included in the set of embedded vectors of the query to each contextualized data embedded vector of in the embedded datastore. The criteria may include a threshold and/or a relevance score. The apparatus may determine the relevance of each contextual data embedded vector based on whether the relevance score associated with each contextual data embedded vector is above the threshold. The at least one contextual data embedded vector may be appended as embeddings and/or tokens to the query and/or portions thereof when the relevance score associated with the at least one contextual data embedded vector is above the threshold.

The relevance score may be determined based on a distance between a vectorized embedding of the query and/or portions thereof and a contextualized data embedded vector of the at least one contextual data embedded vector. When the relevance score of a contextual data embedded vector is above the threshold, the apparatus may select the contextual data embedded vector to append to the query and/or portions thereof for input into the LLM. The apparatus may use a top K-filter to select a subset of contextual data embedded vectors, from the at least one contextual embedded vector, to incorporate with the query for input into the LLM.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 1E is a schematic illustration of an example system environment that may implement an AI/ML model.

FIG. 1F illustrates an example of a neural network.

FIG. 2 includes a system diagram that depicts an example operation of the privacy vault (PV).

FIG. 3 includes a system diagram that depicts an example of the data acquisition flow for acquiring contextual data.

FIG. 4 depicts an example system diagram illustrating the query flow for receiving a query and generating a response.

FIG. 5 depicts an example implementation of converting user information into a vector in a high dimensional space.

FIG. 6 depicts an example implementation where the embedding layers of the (pre)trained LLM may be used as the query processing model.

### DETAILED DESCRIPTION

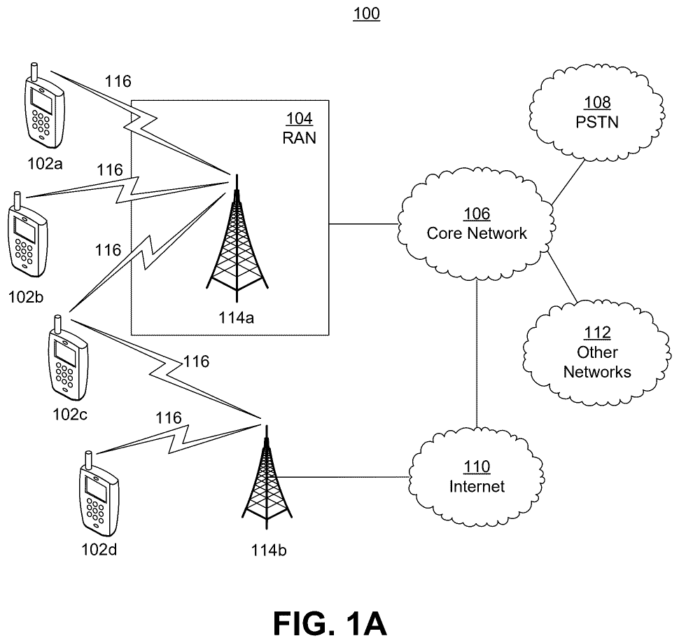

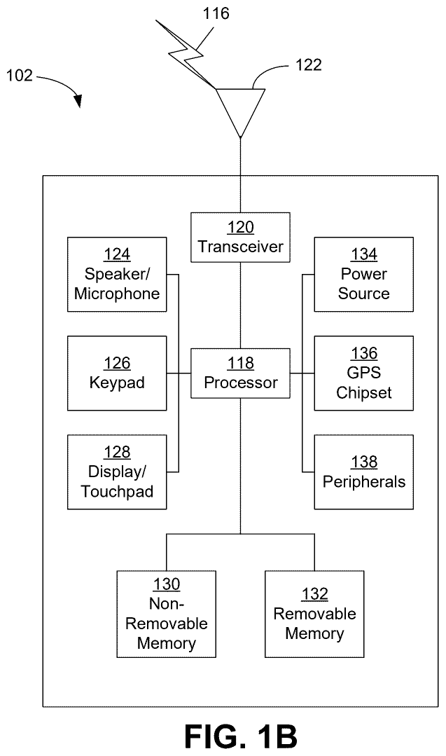

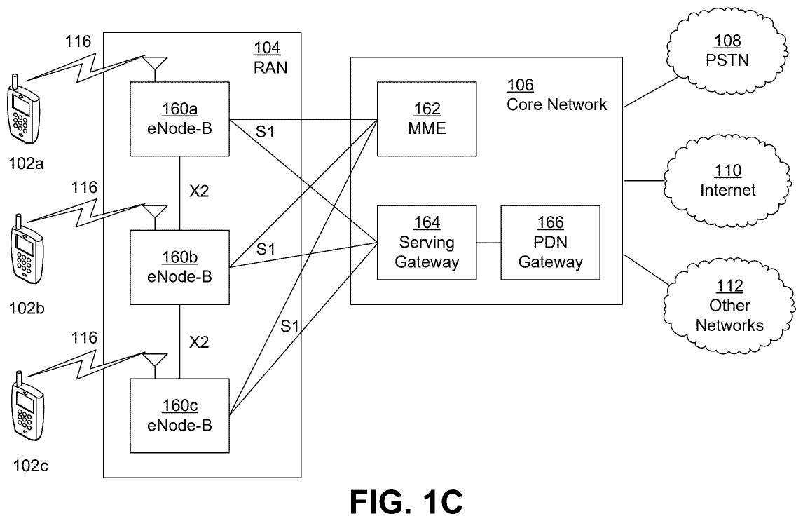

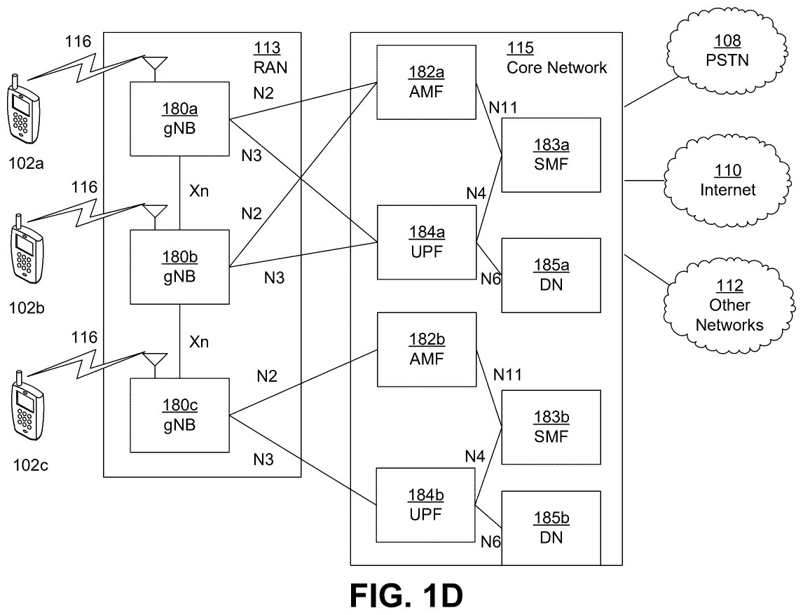

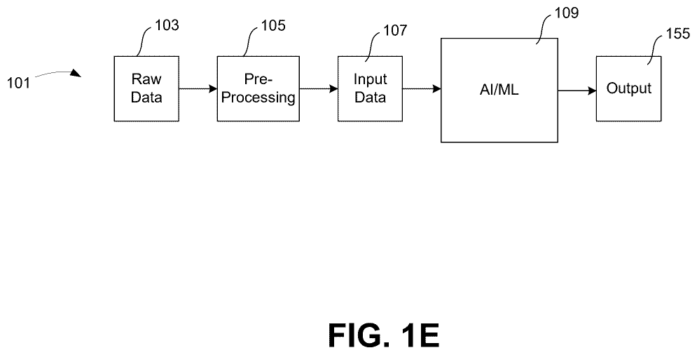

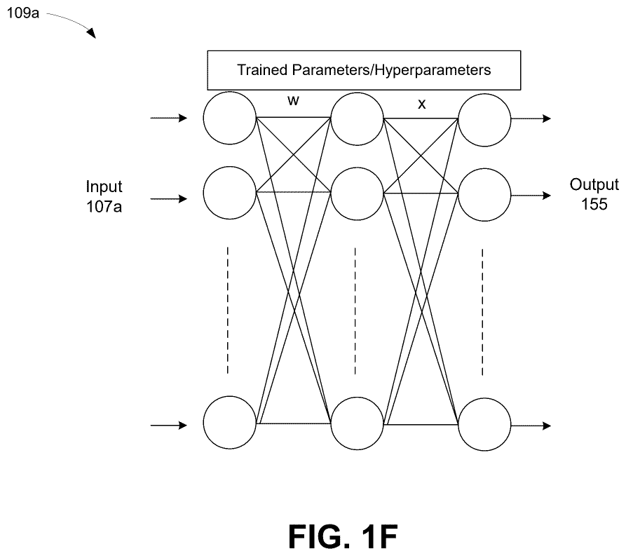

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors.

For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication.

Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS).

The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit).

The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment.

The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c.

Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E is a schematic illustration of an example system environment 101 that may implement an AI/ML 109 model. The AI/ML 109 model may include model data and one or more algorithms and/or functions configured to learn from input data 107 that is received to train the AI/ML 109 and/or generate an output 155. The input data 107 may be input in one or more formats, such as an image format, an audio format (e.g., spectrogram or other audio format), a tensor format (e.g., including single-dimensional or multi-dimensional arrays), and/or another data type capable of being input into the AI/ML 109 algorithms. The input data 107 may be the result of pre-processing 105 that may be performed on raw data 103, or the input data 107 may include the raw data 103 itself. The raw data 103 may include image data, text data, audio data, or another sequence of information, such as a sequence of network information related to a communication network, and/or other types of data. The pre-processing 105 may include format changes or other types of processing in order to generate input data 107 in a format for being input into the AI/ML 109 algorithms. For example, image data (e.g., including video data) and/or audio data may be raw data 103 that may be pre-processed during pre-processing 105 to generate the input data 107 in a format configured to be received by the AI/ML 109 algorithm. The output 155 may be generated by the AI/ML 109 algorithm in one or more formats, such as a tensor, a text format (e.g., a word, sentence, or other sequence of text), a numerical format (e.g., a prediction), an audio format, an image format (e.g., including video format), another data sequence format, or/another output format. Output may include one or more analytics and/or prediction, for example as described herein.

AI/ML may be implemented as described herein using software and/or hardware. The AI/ML may be stored as computer-executable instructions on computer-readable media accessible by one or more processors for performing as described herein.

The AI/ML 109 may include one or more algorithms configured for unsupervised learning. Unsupervised learning may be implemented utilizing AI/ML 109 algorithms that learn from the input data 107 without being trained toward a particular target output. For example, during unsupervised learning the AI/ML 109 algorithms may receive unlabeled data as input data 107 and determine patterns or similarities in the input data 107 without additional intervention (e.g., updating parameters and/or hyperparameters). The AI/ML 109 algorithms that are configured for implementing unsupervised learning may include algorithms configured for identifying patterns, groupings, clusters, anomalies, and/or similarities or other associations in the input data 107. For example, the AI/ML may implement hierarchical clustering algorithms, k-means clustering algorithms, k nearest neighbors (K-NN) algorithms, anomaly detection algorithms, principal component analysis algorithms, and/or apriori algorithms. An autoencoder may be a form of AI/ML 109 that may be implemented for unsupervised learning. The autoencoder may include an encoder configured to transform the input data 107 and/or a decoder that may recreate the input data from the data received by the encoder. The autoencoder may be implemented for processing image data and/or other forms of input data. The AI/ML 109 algorithms configured for unsupervised learning may be implemented on a single device or distributed across multiple devices, such that the output 155, or portions thereof, may be aggregated at one or more devices for being further processed and/or implemented in other downstream algorithms or processes, as may be further described herein.

The AI/ML 109 may include one or more algorithms configured for supervised learning. Supervised learning may be implemented utilizing AI/ML 109 algorithms that are trained during a training process to generate a predictive model. Supervised learning may be trained using known outcomes. The AI/ML 109 algorithms may be characterized by parameters and/or hyperparameters that may be trained during the training process. The parameters may include weights, coefficients, and/or biases. The AI/ML 109 may also include hyperparameters. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 109 may be trained during supervised learning by receiving training data as input to the AI/ML 109 algorithm and adjusting the parameters and/or hyperparameters based on a known target output 155, while minimizing a loss or error in the output 155 generated by the AI/ML 109 algorithm. During supervised learning, the training data may be labeled prior to being input into the AI/ML 109. The parameters of the AI/ML 109 model may be adjusted using to the model using a loss or error function. The trained AI/ML 109 model may receive the validation data as input to evaluate the model fit on the training data set, while tuning the hyperparameters of the AI/ML 109 model. The AI/ML 109 model may receive the test data to evaluate a final model fit on the training data set and to assess the performance of the AI/ML 109 model. One or more of the training, validation, and/or testing may be performed during supervised learning for different types of AI/ML 109 models.

Supervised learning may be implemented for various types of AI/ML 109 algorithms, including algorithms that implement linear neural networks (NNs), Deep NNs (DNNs), and/or support vector machines (SVMs). NNs and Deep NNs (DNNs) are examples of algorithms utilized in AI/ML models that may be trained using supervised learning. Various examples of NNs include: feed-forward NNs, fully-connected NNs, convolutional Neural Networks (CNNs), recurrent NNs (RNNs), etc.

FIG. 1F illustrates an example of a neural network 109a. The objective of training may be to apply the input 107a as training data and/or adjust one or more weights, indicated as w and x in FIG. 1F (e.g., which may be referred to as neuron weights and/or link weights), such that the output 155 from the neural network 109a approaches the desired target values which are associated with the input 107a values for the training data. In examples, a neural network may include three layers (e.g., as shown in FIG. 1F). During the training, for given input, the difference between output and desired values may be computed and/or the difference may be used to update the one or more weights in the neural network. If a significant (e.g., above a defined threshold) difference between output and desired value(s) is observed, for example, one or more relatively significant (e.g., above a defined threshold) changes in one or more weights may be expected. A difference below a threshold (e.g., between output and desired value(s)) may include one or more relatively small changes (e.g., below a threshold distance) in one or more weights.

Training a neural network 109a may include identifying one or more of the following information: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs)) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm.

One or more apparatus, or portions thereof, described herein as being implemented in a network may implement one or more artificial intelligence (AI)/machine learning (ML) models, as described herein. A large language model (LLM) may be a type of AI that uses ML to process natural language. LLMs can generate and/or translate text, perform natural language processing (NLP) tasks, and/or the like. Additionally or alternatively, LLMs can summarize, answer questions, and/or classify text. LLMs may be trained on large amounts of data and/or may use deep learning architecture(s) like the Transformer to learn the relationship(s) between words and phrases. LLMs can respond to user request(s) with relevant content in human language.

For an entity and/or organization with unique behavioral characteristics, the answer to subjective queries may be based on the context in which the query is asked. One or more (e.g., regular) LLMs may be weak at identifying and/or utilizing subjective information, which may result in generic response to subjective queries that may be of little to no utility. Providing context to the LLM may require significant prior knowledge related to the query and/or the user providing the query, and/or a mechanism to acquire and/or process contextual information pertaining to both. Acquisition and/or processing of this information may not be trivial. A system which incorporates this may require communication channel(s) between one or more (e.g., several) heterogenous sensing devices and a method to process and/or represent such information in a way that can be ingested by the LLM.

One or more of the methods described herein may be used to address this problem. For example, a LLM may be fine-tuned, (re)trained, and/or used with one or more of the following methods (e.g., RAG). A first method may include supplying the context at the time of the query via retrieval-augmented generation (RAG). In this method, the relevant information may be fed to the LLM manually as a sequential input. RAG may not include training and/or retraining of the LLM. The LLM may be used as an (e.g., existing, trained) LLM. Each time the LLM is used (e.g., asked for information), the LLM may augment the query (e.g., question) with information from an existing source (e.g., documents). For example, the LLM may receive a PDF file about research. The LLM may be asked how it is done. The LLM may find answer(s) from the PDF. A second method may include augmenting the corpus of training information with the relevant context and/or conditional information during training time. For example, a LLM may be fine-tune and/or (re)trained (e.g., from scratch). The LLM may augment (e.g., existing) datasets based on other (e.g., personalized) information to fine-tune and/or (re)train. The LLM may start with a pre-trained LLM and/or may be fine-tuned (e.g., with personalized information). A third method may include training conditional version(s) of the LLMs themselves, which may accept context and/or other conditional information as auxiliary input. For example, one or more LLMs may be trained to be expert in a specific field. At inference time, based on the query (e.g., question), the model may determine which LLM to use to generate the response. One or more of the systems described herein may make assumptions about the availability and/or processing requirements to obtain contextual information, and/or may determine that context is stationary. Additionally or alternatively, one or more systems described herein may not incorporate additional context once the LLM has been trained, and/or may (e.g., only) utilize it on the inference side.

Embodiments described herein may provide a procedure for LLMs to access contextual information to improve their responses. The LLMs may access contextual information while preserving the user privacy. Accessing and/or collecting context information may be handled by a hardware/software module referred to as a Privacy Value (PV). The PV may collect information from one or more (e.g., several) modalities and/or may process them into a (e.g., suitable) format. The PV may generate the context without user intervention and/or explicit interaction with the LLM itself. The PV can reside at a secure location within user/organization jurisdiction, and/or the information can be accessed if and/or when needed. A secure location may refer to hardware containing the information may be located in a place where physical access to it is not possible by entity(ies) (e.g., people) outside an organization. For example, premise servers may be considered to be in a secure location in comparison to cloud servers (e.g., which may not be in a secure location). The context data may be captured in one or more different modalities (e.g., images, videos, voice, text, etc.) by one or more different sensing devices and/or stored in a set of (e.g., local) data sources. For example, the data sources can be on servers of an organization. For example, in a personal use case (e.g., at home), the data source(s) can be the information on the user's mobile phone that may be connected to the private home network. The PV may have access to these data sources. The PV can communicate with a local device/server hosting the LLM. One or more modules may be located inside the apparatus in a secure private network. User information in a datastore may be protected and/or isolated from the outside world (e.g., the public internet). For example, user information may be encrypted from external communications and not accessible from other networks. The received query and/or the generated response may be communicated from/to the user device through a different network. This may be the communication that happens outside the private network. This can be a secure communication over the internet using secure communication (e.g., using secure sockets layer (SSL)). For example, the apparatus may be configured such that the user information stored as contextualized data embedded vectors in the datastore can (e.g., only) be used to augment a query to LLM. An entity (e.g., person) may not be able to retrieve (e.g., original) user information (e.g., images, videos, etc.) from the contextualized data embedded vectors in the datastore of the apparatus.

One or more privacy fault functions may be described herein. The PV may accept one or more (e.g., multiple) modes of information as input (e.g., photos, videos, text, etc.). The PV may accept queries from the users. For example, query may be in the form of plain text. The PV may pass input information through an internal embedding module (EM) to obtain embedding vectors, which may be stored in an embedding datastore (ED) for future use. When receiving an input query, for example, the PV may match the input query to embedding vector(s) corresponding to information relevant to the user's query. The query may be augmented with these vectors before being passed to the LLM. The output of the LLM may be decoded in the form of text/image/video. The PV output may be a block of data (e.g., can be a mixture of text, image, and/or video), which may be transmitted to the user device over the (e.g., local, secured) network. Embodiments described herein may include the LLM, QPM, and/or EM using similar (e.g., the same) embedding layers as the LLM. For example, the LLM, QPM, and/or EM may not (e.g., need to) be (re)trained.

The PV may allow the user queries to benefit from the locally available information, which may result in richer, more accurate and/or personalized output(s) from the LLM. The PV may train its mapping module locally to identify and/or map relevant information to queries, which may continuously make it more accurate and/or adaptive to other information. For example, the embedding module and/or the information mapping module may be trained similarly to how the LLM is trained (e.g., based on supervised learning, based on unsupervised learning). A method of training may include randomly masking one or more words from a large corpus of training text and learning to predict the masked words. A method of training may include, for example, predicting how probable it is for a sentence to follow another sentence in the text (e.g., which may represent how relevant the two sentences are). The embedding layers of an LLM may be trained end-to-end with the whole LLM model. For example, the embedding layers of an LLM may work for only that LLM. One or more models herein may be trained based on a dataset (e.g., agnostic to a specific user). The PV functionality may be completely local and/or may not require internet connectivity. Dedicated line(s) of communication between PV and user device may be included (e.g., as the only connectivity necessary).

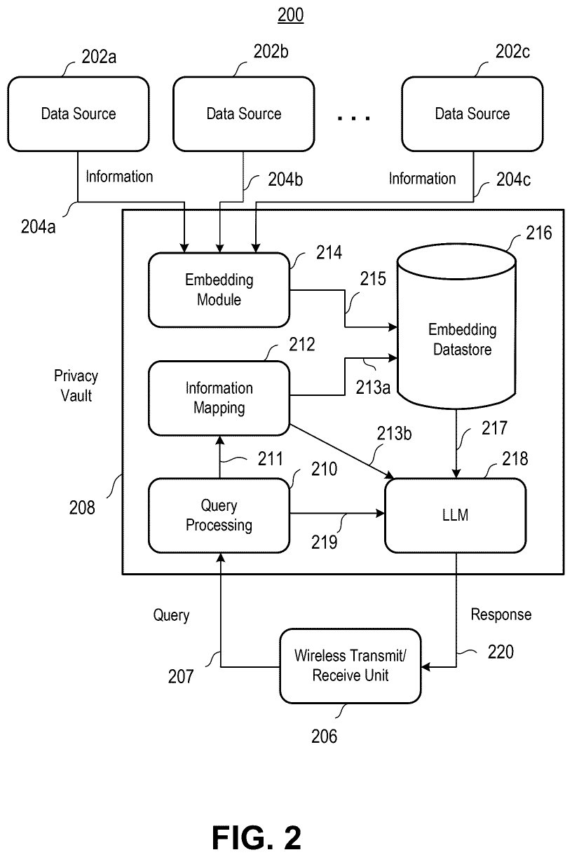

FIG. 2 includes a system diagram that depicts an example operation 200 of an apparatus 208. The apparatus 208 may be or include a privacy vault. The privacy vault may include an embedding module 214, an information mapping module 212, a query processing module (QPM) 210, an embedding datastore 216 and/or a large language module (LLM) 218.

One or more data sources (e.g., 202a, 202b, 202c) may send information (e.g., at 204a, at 204b, at 204c), to an embedding module 214. The information may include audio data (e.g., mp3, wav, flac, etc.), text data (e.g., txt, pdf, doc, etc.), and/or image and/or video data (e.g., png, jpeg, mp4, etc.).

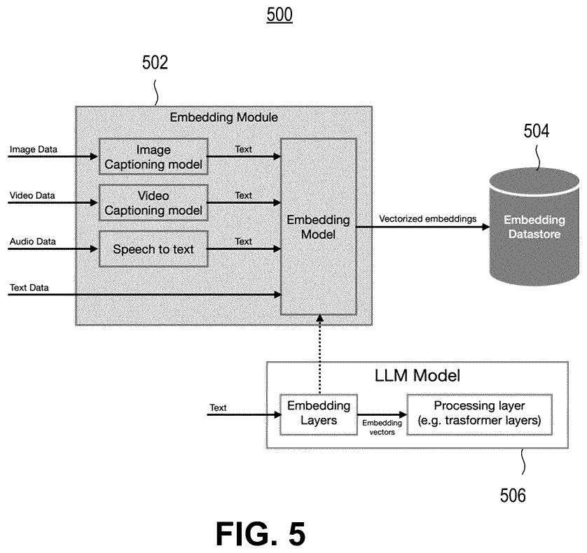

As shown in FIG. 5, the embedding module 214 may convert each unit of information (e.g., audio data, text data, image and/or video data, and/or one or more other modalities) into a vector in a high-dimensional embedding space. The embedded module 214 may be and/or include an AI/ML model that converts each unit of embedded information to the vector(s) in the high-dimensional embedding space. The embedded module 214 may use one or more embedded layers from the LLM 218. The embedded module 214 may be fine-tuned and/or (re)trained (e.g., as described herein) such that each vector (e.g., embedded vector) is compatible with each contextualized embedded data vector in the datastore 216. The embedded vectors may be compatible with the embedding used by the LLM. One or more (e.g., two) aspects may be associated with compatibility of embedded vectors (and/or compatibility among embedded vectors from the QPM and contextualized data embedded vectors in the datastore). A first aspect may include having the same data type and/or dimensionality. For example, a 100-dimensional vector may not be compatible with a 200-dimensional vector. For example, a vector with real values may not be compatible with a vector with complex values. A second aspect may include each (e.g., embedded) vector coming from the same distribution of data and/or representing shared meaning. For example, if two vectors are close (e.g., within a threshold distance) to each other (e.g., having similar values), they may represent similar meanings and/or components.

An embedding model may generate vectorized embeddings by training a neural network on a dataset of points. The embedding model and/or the information mapping model may be trained similarly to the LLM (e.g., as described herein). The embedding module and/or query processing module may use one or more embedded layers similar to and/or from the LLM. The query processing module and/or embedding module that uses one or more embedded layers similar to and/or from the embedded layer(s) of the LLM may help with compatibility of the decomposed embedded vectors associated with the query to the contextualized embedded data vectors at the datastore. The embedding model may associate numerical numbers to portions of each data point of a dataset to identify semantic and/or syntactic relationships within that data point in the dataset. For example, the embedding model may assign different numerical values to different words in a textual data point in the dataset. The embedding model may convert user information (e.g., words, images, audio) and/or portion(s) thereof to high-dimensional vector representation of the semantic and/or syntactic relationships of the points of data which may represent the data points in a high dimensional embedding space. Each data point in the dataset may be converted to a vector and may be used for analysis and/or prediction(s). A vector may include one or more dimensions. Each dimension may represent a unique numerical value of a feature and/or aspect of the data in the dataset. The embedding model may be trained on the one or more vector representations, for example, to optimize an objective function. For example, the embedding model may be trained to minimize distance between one or more vectors in an embedded space. Minimal distance may represent a strong semantic and/or syntactic relationship between the one or more vectors in the embedded space based on one or more features/aspects/dimensions of the vector(s) being considered. A semantic relationship may represent similar data points and/or vector representations. For example, a model (e.g., Word2Vec, GloVe, wordpiece, sentencepiece, ELMo, and/or the like) may analyze distinct words in a document to identify meaning and/or context of the words within the text to determine semantic relationship(s) among the words. Each word may be assigned a vector; similar words may have similar vectors. Similarly, image data and/or portion(s) thereof may be converted to vector(s) in the embedded space using a neural network (e.g., convolutional neural networks (CNNs). Audio data and/or portions thereof may be converted to embedded vectors in the embedded space using, for example, Mel Frequency Cepstral Coefficietions (MFCCs) to convert one or more feature(s). Image and/or video captioning model(s) may convert the information into text. Speech to text model(s) can, additionally or alternatively, convert audio information into text. At 215, the embedding module 214 may send one or more vectorized embeddings (e.g., as described herein) to the embedding datastore 216.

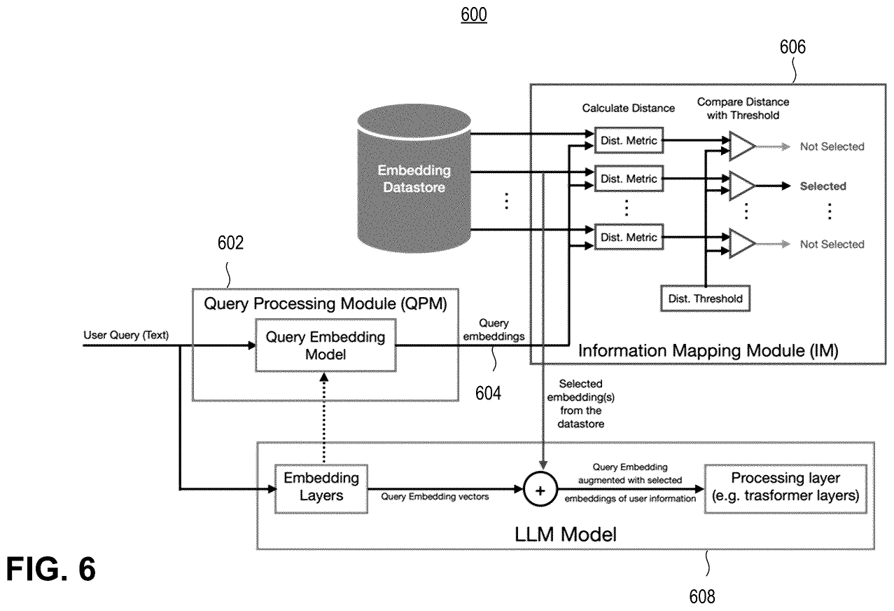

At 207, a wireless transmit/receive unit (WTRU) 206 may send a query to the apparatus 208. An apparatus 208 may receive the query from the WTRU 206. The query may include a textual and/or audio query for information in a response. The WTRU 206 may send the query to the QPM 210. The QPM 210 may be and/or include an AI/ML model (e.g., neural network-based model, as described herein). The QPM 210 may include a query embedding model. The QPM may take as input the user in text format and may output a set of vectorized embeddings. For example, the QPM may decompose (e.g., as shown in FIG. 6) the query into one or more embedded vectors in an embedded space. For example, QPM 210 may decompose the query and/or portions of the query to independent components. Each independent component may be converted to an embedded vector. Embedded layer(s) at the QPM 210 may be similar to one or more embedded layers at the embedding module 214 and/or the LLM 218. The QPM 210 may use the one or more embedded layers to convert the query and/or portions of the query to one or more embedded vectors. The vectorized embeddings may be compatible with the contextualized data embedded vectors in the embedded datastore. The set of vectorized embeddings may include the embedded vector. The QPM may decompose the query into the set of embedded vectors such that each embedded vector included in the set of embedded vectors is compatible with each contextual data embedded vector. The QPM may send one or more query embeddings (e.g., embedded vectors associated with the query) to the information mapping model (IM) 212. In one or more other implementations, a neural network model may be trained on a dataset of input queries and/or user information (with different modalities) to create embedding vectors. The same model can be used in QPM and/or EM module(s) to create compatible vectorized embeddings. The QPM 210 may be trained (e.g., as described herein) similarly to how the embedding module 214 and/or LLM 218 are trained. For example, the QPM may employ a classification problem technique to identify one or more of missing word(s), selecting missing words in vocabulary, and/or identifying a strongest word to choice to the missing word.

At 213a and/or 213b, the IM 212 may calculate relevancy for each query embedding (e.g., as shown in FIGS. 5 and 6). The IM 212 may be an AI/ML model (e.g., neural network).

The AI/ML model at the IM 212 may be trained. For example, the AI/ML model may receive, as input, two sets of vectors (e.g., a first set from the embedded datastore 216 and/or a second set of vectors from the query) to compare. The IM 212 may output a value (e.g., number) indicative of how close the vectors are (e.g., within a threshold distance). A small value (e.g., below a threshold) may indicate the two vectors are close (e.g., within a threshold distance). The AI/ML model at the IM may be trained based on a loss function (e.g., distance between what the AI/ML model predicted as relevant and the ground truth). Ground truth may be from the dataset(s) associated with the vectors. The distance may include mean squared error. The IM may be a non-AI/ML model. The IM 212 may be and/or include one or more mathematical formulas and/or algorithms and/or equations to calculate how relevant each embedded vector associated with the query is to one or more contextual data embedded vectors in the datastore. For example, the IM 212 may use an Euclidean distance-based and/or cosine similarity-based calculation (e.g., algorithm, non-AI/ML model) to determine how relevant each embedded vector associated with the query is to one or more contextual data embedded vectors in the datastore. The IM 212 may identify at least one contextual data embedded vector that is relevant to at least one portion of an embedded vector associated with the query based on a criteria. For example, the IM 212 may calculate a distance metric associated with each query embedding (e.g., as described herein). The IM 212 may compare each distance metric with a (pre)configured threshold. For example, an apparatus may identify at least one of the vectorized embedding information (e.g., contextual data embedding vectors) above a threshold relevance score for being selected for input into a large language model (LLM) 218. For example, the IM 212 may calculate a relevancy score for each query embedding (e.g., as described herein). As shown in FIG. 6, at 217, the IM 212 may send the selected (e.g., as described herein) embeddings from the embedding datastore 216 to the LLM 218. For example, the IM 212 may select one or more contextualized data embedded vectors that are associated with a distance metric below a (preconfigured) threshold and/or a relevance score that is above a (pre)configured threshold. To find the most relevant vectorized information from the datastore, a distance metric can be used together with a threshold value. For example, the MSE between the query vector(s) and the vectorized information in the datastore can be used as the distance metric. The smaller MSE in this case may represent closer vectors (e.g., below a threshold distance), which may mean more relevant vectors. One or more threshold value(s) can be used to select the relevant vector(s) from the datastore; the distance may be calculated between the query vectors and one or more vectorized embeddings in the datastore. The embeddings in the datastore corresponding to the distances that are less than the specified threshold value(s) may be selected. At 213b, the IM 212 may send the selected contextual data embedded vector(s) (e.g., as a second input) to the LLM 218. For example, the IM 212 may use an application programming interface (API) to retrieve information (e.g., contextual data embedded vector(s)) from the embedded datastore. The embedded datastore may use a database software (e.g., Casandra, MongoDB) to provide the application programming interface (API) which is used by IM 212. Additionally or alternatively, at 213a, the IM 212 may query the embedded datastore 216 such that the embedded datastore 216 is configured to send (e.g., at 217) the selected contextual data embedded vector(s) (e.g., as a second input) to the LLM 218. The IM 212 may map one or more embedded vectors from the QPM 210 to the embedded vectors from the embedded module 214 to ensure each embedded vector from the query is compatible (e.g., as described herein) with the contextual data embedded vectors at the embedded datastore 216 and/or the LLM 218. The IM 212 may employ one or more mechanisms to determine which selected contextual data embedded vector(s) are sent to the LLM 218. For example, the IM 212 may use a Top-K filter to identify the top K (e.g., 10) contextual data embedded vectors to send to the LLM 218. For example, if the IM 212 identifies twenty-five contextual data embedded vectors as relevant (e.g., based on a respective relevance score and/or distance metric, as described herein), and the IM 212 employs a Top-K filter with K=10, the IM 212 may send the ten most relevant (e.g., lowest distance, highest relevance score) contextual data embedded vectors to the LLM 218. For example, the apparatus may use a top K-filter to select a subset of contextual data embedded vectors, from the at least one contextual embedded vector, to incorporate with the query for input into the LLM.

A LLM may receive one or more (e.g., two) inputs. For example, at 219, the LLM 218 may receive (e.g., as a first input) the query from the QPM 210. As shown in FIG. 6, embedded layers at the LLM 218 may convert the query to one or more embedded vectors. At 213a and/or 213b, the LLM 218 may receive (e.g., as a second input) the selected contextual data embedded vector(s). The LLM 218 may augment the embedded vectors associated with the query with the contextual data embedded vector(s). For example, the at least one contextual data embedded vector may be incorporated with the query based on the criteria (e.g., relevancy score). The at least one contextual data embedded vector incorporated with the query and/or portions of the query may include the at least one contextual data embedded vector appended as embeddings and/or tokens to the query and/or portions thereof. In an example, the LLM 218 may receive a query (e.g., 219). The query may be converted to one or more (e.g., ten) embedded vectors. The IM 212 may select five contextual data embedded vectors as relevant based on the criteria (e.g., relevancy score). The IM 212 and/or embedded datastore 216 may send the five selected contextual data embedded vectors to the LLM 218. The LLM 218 may incorporate (e.g., as described herein) one or more (e.g., five) selected contextual data embedded vectors with the query (e.g., embedded vectors associated with the query, the ten embedded vectors generated by the embedded layers at the LLM 218).

The large language model (LLM) 218 may be responsible for local processing of user queries augmented by the contextual information identified by the IM. The context information can be appended as embeddings and/or as tokens in the input of the large language model.

This may allow the LLM 218 to benefit from personalized, contextual information that the system has collected to produce richer, more personalized outputs. The LLM 218 may be trained (e.g., as described herein) on sample queries and/or vectorized embedding information (e.g., contextual data embedding vectors) identified as relevant to the requested query. For example, LLM 218 may be trained using a self-supervised learning process. LLM 218 may be exposed to a large amount of text data and/or may learn to predict the next word in a sequence. LLM 218 may be trained to understand language pattern(s) and/or structure without (e.g., explicit) labels. LLM 218 may be, additionally or alternatively, fine-tuned (e.g., on specific datasets), for example, to tailor the LLM (e.g., model) for one or more particular tasks (e.g., translation, question answering). The LLM may be trained with different questions and different contextual information for a particular implementation. For example, the LLM may be trained with particular questions related to a particular topic and/or predefined contextual information related to the selected topic or topics for providing relevant responses. The LLM may be trained with one or more questions in a given request, and one or more vectorized embedding information providing context for the given request. The at least one vectorized embedding information (e.g., contextual data embedding vectors) above the threshold may be appended as embeddings and/or tokens to the query and/or portions thereof. The LLM 218 may augment the query based on the selected embeddings (e.g., sent at 217) to generate a response. For example, the LLM 218 may output a response (e.g., contextualized response) to send to the WTRU. At 220, the LLM 218 may transmit a response (e.g., contextualized response) to the WTRU. The apparatus may transmit the contextualized response via a (e.g., local, secure) network to the WTRU. For example, secure network may indicate that the response (e.g., contextual response) is received (e.g., only) by the intended user(s). The contextualized response may be and/or include a text (e.g., text data). The contextualized response may be and/or include one or more other modalities (e.g., image), for example, based on the type of LLM and/or the query.

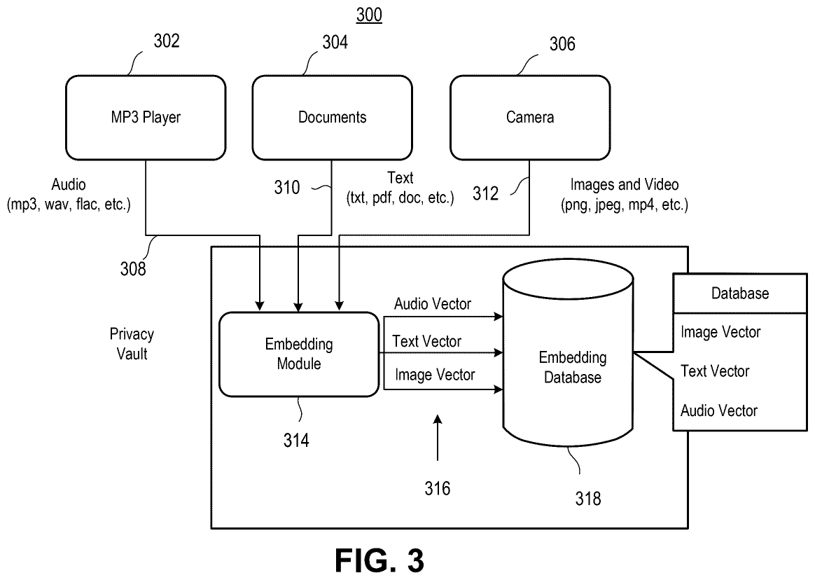

FIG. 3 includes a system diagram that depicts an example of the data acquisition flow for acquiring contextual data. The PV may collect multi-modal information from one or more (e.g., multiple) sources and/or may store it as a set of vectors. One or more data sources may send information (e.g., as described herein) to the embedding module 314.

The embedding module 314 may include a speech to text model, an image to text model, a video captioning to text model, and/or an embedding model. The apparatus may receive, at an embedding model, contextual data related to potential queries from a user for information at an embedding model. The contextual data may include at least one of textual data, audio data, and/or video data from a corresponding source. For example, a MP3 player 302 may send, at 308, audio data (e.g., mp3, wav, flac, etc.) to an embedding module 314. For example, at 310, documents 304 (e.g., txt, pdf, doc., etc.) may be sent to the embedding module 314. Documents may represent one or more (e.g., any) textual information stored on a user device. For example, documents may include text messages, emails, and/or other information in text format that may be useful in personalizing the LLM's response. For example, a camera 306 may send, at 312, image data and/or video data to the embedding module 314. The image data and/or video data may include, for example one or more of png, jpeg, mp4, and/or the like. The embedding module 314 may generate vectorized embedding information (e.g., contextual data embedded vectors) based on the received data (e.g., audio data at 308, text data at 310, image and/or video data at 312). The embedding module 314 may generate one or more embedded audio vectors (e.g., as shown in FIG. 5) based on the audio data. The embedding module 314 may generate one or more embedded text vectors (e.g., as shown in FIG. 5) based on the text data. The embedding module 314 may generate one or more embedded image vectors (e.g., as shown in FIG. 5) based on the image data. The embedding module 314 may generate one or more embedded video vectors (e.g., as shown in FIG. 5) based on the video data. Each user data point (e.g., image, text, document, video, and/or audio) may be converted to an embedding vector. Each embedding vector may represent the semantic and/or components from the data point. The embedding vector may be (e.g., all) the same format and/or dimensionality and/or may be indistinguishable whether the source was text, audio, image, and/or video. The vectorized embedding information (e.g., contextual data embedded vectors) may include and/or be based on one or more of the embedded audio vector(s), the embedded image vector(s), the embedded text vector(s), and/or the embedded video vector(s). At 316, the embedding module may send one or more of the embedded audio vector(s), the embedded image vector(s), the embedded text vector(s), and/or the embedded video vector(s) to the embedding datastore 318. The apparatus may store the vectorized embedding information (e.g., contextual data embedded vector(s)) in an embedded datastore. The embedding model may be trained to receive the contextual data and/or may generate different contextual data embedded vectors each comprising a vector of values configured to identify semantic and/or syntactic relationships between different contextual data via spatial relationships in a spatial domain.

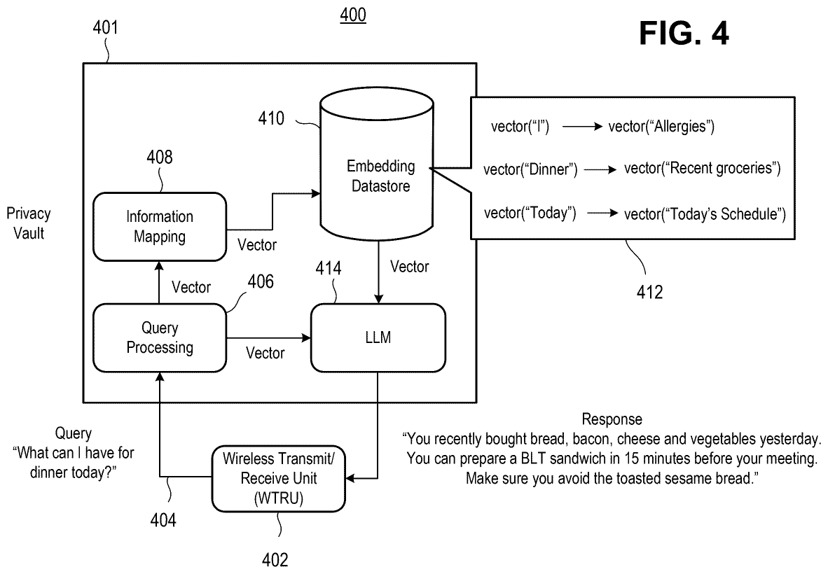

FIG. 4 depicts an example system diagram illustrating the query flow for receiving a query and generating a response. For example, after the PV receives the query from the user, the query vector(s) may be matched against stored information to find relevance. Relevant stored information may be used to augment the responses. At 404, the apparatus 401 may receive a query from a WTRU 402. The query may include a textual, and/or audio query for information in a response. The query may include one or more (e.g., other) modalities. For example, the query may include an image and a query to ask for what is showing to identify the image (e.g., a special animal, plant's name); similar to RAG (e.g., as described herein). For example, the query may ask “what can I have for dinner today?” The QPM 406 may decompose the query (e.g., as described herein, via tokenization and/or token embedding) into a set of vectorized embeddings. For example, the apparatus, at a QPM, may decompose the query into a set of vectorized embeddings. The apparatus may decompose the query into the set of vectorized embeddings such that each embedded vector included in the set of embedded vectors is compatible with each contextual data embedded vector (e.g. included in the at least one contextual embedded vector). As described herein, compatibility may include dimensionality of at least a portion of a decomposed embedded vector from the query aligning with the dimensionality of a contextualized data embedded vector in the embedded datastore. The IM may implement one or more mechanisms to map the dimensionality such that decomposed embedded vector is compatible with the contextualized data embedded vector. The set of vectorized embeddings may include the embedded vector. The set of vectorized embeddings may be sent to the IM 408 and/or to the LLM. The QPM may be trained similar to the embedding module and/or the LLM.

The apparatus may identify at least one contextual data embedded vector that is relevant to at least one portion of an embedded vector based on a criteria. The apparatus may calculate (e.g., at an IM), relevance of each embedded vector and/or portions thereof of the query to each contextualized data embedded vector in the embedded datastore 410 based on criteria to identify the at least one contextual data embedded vector that is relevant to the at least one portion of the embedded vector. For example, the query may be decomposed into one or more vectors. A first embedded vector may be associated with the word I. A second embedded vector may be associated with the word dinner. A third embedded vector may be associated with the word today. The IM may determine one or more contextual data embedded vectors 412 associated with the one or more embedded vectors. For example, the first embedded vector may be associated with a contextualized data embedded vector associated with one or more allergies associated with the user (e.g., the word I). For example, the second embedded vector may be associated with one or more contextual data embedded vectors associated with the recent groceries. For example, the third embedded vector may be associated with one or more contextual data embedded vectors associated with today's schedule.

The criteria may include a threshold and/or a relevance score. The apparatus may determine the relevance of each contextual data embedded vector to the at least one portion of the embedded vector associated with the query based on whether the relevance score associated with each vectorized embedding of the query and/or portions thereof is above the threshold. One or more contextualized data embedded vectors associated with the first vectorized embedding may include a relevance score above the threshold.

The apparatus may determine that one or more contextualized data embedded vectors associated with the first vectorized embedding (e.g., and/or portions thereof) includes a relevance score above the threshold. For example, the apparatus may determine that that one or more contextual data embedding vectors associated with allergies (e.g., sesame) are relevant to one or more decomposed vectorized embeddings (e.g., and/or portions thereof) associated with the user (e.g., word I). The IM may select one or more contextual data embedded vectors (e.g., associated with the word allergies) that include a relevance score above the threshold. The apparatus may append the one or more selected (e.g., relevant) contextual data embedded vectors (e.g., associated with allergies based on the word I) to the decomposed vectorized embeddings of the query and/or portions thereof based on a determination that the one or more contextual data embedded vectors are above the threshold of relevancy (e.g., have a relevance score above the threshold). The IM 408 may employ one or more mechanisms to determine which selected contextual data embedded vector(s) are sent to the LLM 414. For example, the IM 408 may use a Top-K filter to identify the top K (e.g., 10) contextual data embedded vectors to send to the LLM 414. For example, if the IM 408 identifies twenty-five contextual data embedded vectors as relevant (e.g., based on a respective relevance score and/or distance metric, as described herein), and the IM 408 employs a Top-K filter with K=10, the IM 408 may send the ten most relevant (e.g., lowest distance, highest relevance score) contextual data embedded vectors to the LLM 414. For example, the apparatus may use a top K-filter to select a subset of contextual data embedded vectors, from the at least one contextual embedded vector, to incorporate with the query for input into the LLM. There may be other criteria, for example, to limit the complexity calculation(s) by limiting the number of contextual vectors at a maximum. Other types of filters may be used to control the number of contextual data embedded vectors to be introduced with the query to generate the contextual response.

For example, the apparatus (e.g., IM) may determine that one or more contextualized data embedded vectors associated with the second vectorized embedding (e.g., and/or portions thereof) includes a relevance score above the threshold. For example, the apparatus (e.g., IM) may determine that one or more contextualized data embedded vectors associated with recent groceries (e.g., bread, bacon, cheese, vegetables) are relevant to one or more decomposed vectorized embeddings (e.g., and/or portions thereof) associated with the word dinner. The IM may select one or more contextual data embedded vectors (e.g., associated with recent groceries) that include a relevance score above the threshold. The apparatus may append the one or more selected (e.g., relevant) contextual data embedded vectors (e.g., associated with recent groceries based on the word dinner) to the decomposed vectorized embeddings of the query and/or portions thereof based on a determination that one or more contextual data embedded vectors are above the threshold of relevancy (e.g., have a relevance score above the threshold).

For example, the apparatus may determine that one or more contextualized data embedded vectors associated with the third vectorized embedding (e.g., today) includes a relevance score above the threshold. For example, the apparatus may determine that one or more contextual data embedded vectors associated with today's schedule are relevant to one or more vectorized embeddings (e.g., and/or portions thereof) associated with the word today. The IM may select one or more contextual data embedded vectors (e.g., associated with today's schedule) that include a relevance score above the threshold. The apparatus may append the one or more selected (e.g., relevant) contextual data embedding vectors to the decomposed vectorized embeddings of the query and/or portions thereof.

The at least one contextual data embedded vector may be appended as embeddings and/or tokens to the query and/or portions thereof when the relevance score associated with the at least one contextual embedded vector is above the threshold. The relevance score may be determined based on a distance between a vectorized embedding of the query and/or portions thereof and a contextualized data embedded vector of the at least one contextual data embedded vector (e.g., stored in the embedded datastore). For example, when the relevance score of a contextual data embedded vector is above the threshold, the apparatus may select the contextual data embedded vector to append to the query and/or portions thereof for input into the LLM 414.

The apparatus may input the query and/or portions thereof and/or the at least one contextual data embedded vector 412, based on the criteria, to a LLM 414. The LLM 414 may be trained on sample queries and/or contextual data embedded vectors identified as relevant to the requested query. The at least one contextual data embedded vector (e.g., at 412) may be incorporated with the query based on the criteria. For example, the at least one contextual data embedded vector incorporated with the query and/or portions of the query may include the at least one contextual data embedded vector appended (e.g., as embeddings and/or tokens) to the query and/or portions of the query. The apparatus may receive a contextualized response to the query from the LLM 414 based on the at least one contextual data embedded vector incorporated with the query, based on the criteria. The LLM 414 may send a response to the WTRU 402. The response may be in text format. Based on the query and/or LLM capability(ies), one or more other modalities of data may be included in the response. For example, the query may ask to draw a cartoon image of a person (e.g., the user) standing with mountains in the background. In examples, the response may be and/or include an image. The response may include: You recently bought bread, bacon, cheese, and vegetables yesterday. You can prepare a bacon lettuce tomato (BLT) sandwich in 15 minutes before your meeting. Make sure you avoid the toasted sesame bread. The LLM may be configured to generate the response based on the decomposed vectorized embeddings (e.g., as described herein) and the contextual data embedding vector(s) selected (e.g., identified as relevant) to append and/or augment the response. For example, the apparatus may be configured to generate a response that takes into account the user being allergic to sesame and/or a component thereof based on the one or more contextual data embedding vectors associated with allergies. For example, the apparatus may be configured to generate a response that takes into one or more constraints and/or restrictions (e.g., time restrictions, scheduling restrictions based on today's schedule) based on the one or more contextual data embedding vectors associated with today's schedule.

FIG. 5 depicts an example implementation of converting user information into a vector in a high dimensional space. The input information can take one or more different modalities (e.g., video, text, audio, etc.). The embedding module may produce a vectorized representation of a unit of input information. This representation may carry semantic meaning for the downstream machinery. One or more relationships between components (e.g., semantics of the information in different vectors) may be represented by distances and/or angles between vectors. For example, one or more spatial relationships may be indicated via distances and/or angles. For example, the datastore may include a vector that originated from an email discussing an online purchase and a vector from the user query that is asking about when was the last time the user (e.g., I) visited Paris. The distance between these two vectors may be large because based on (lack of) relevancy. Deep learning models trained to distinguish between components which carry different meanings may be used to produce these embeddings. One or more measures of distance between these embeddings may determine the similarity of the components represented by them. The EM 502 may map the input information to vectors whose magnitude and/or angle are determined by their relationship to other component(s). This may allow the system to establish a common semantic space for relevance calculations (e.g., Euclidean distance-based calculation(s), cosine-similarity based calculation(s), and/or one or more other distance and/or similarity metrics). The EM 502 may (re)use the embedding layers of the LLM (e.g., instead of training a new embedding model).

The embedding module 502 may convert each unit of information into a vector in a high dimensional embedding space. The embedding module 502 may include a video to text model, an audio to text model, a speech to text model, and/or an embedding model. Although another embedding model can be trained, in example implementation(s), the (pre)trained embedding layer(s) of the LLM model can be used as the embedding model inside the embedding module 502. The following may illustrate an exemplary workflow that can be used to embed information into vectors in a high dimensional embedding space. One or more other workflows can be used for this conversion.

A first procedure may include one or more (e.g., all) modalities being converted to text. This can be considered the preprocessing procedure. For example, the images and/or video clips can be converted to text using image and/or video captioning model(s). For example, an image captioning model may convert image data to text (e.g., text data). For example, a video captioning model may convert video data to text (e.g., text data). The audio input(s) can, additionally or alternatively, be converted to text using speech to text models. For example, a speech to text model may convert audio data to text (e.g., text data). The text input may include, for example, emails, text messages, notes, stored documents, and/or the like. The image and/or video may include, for example, the photo library on the device. The audio data may include, for example, recorded text, recorded messages, and/or the like. Additionally or alternatively, the embedding model may receive text data. For example, an apparatus may receive, at an embedding module 502, contextual data related to potential queries from a user for information at an embedding module. The contextual data may include at least one of textual data, audio data, and/or video data. The embedding module may be trained to receive the contextual data and/or generate different vectorized embedding information (e.g., contextual data embedded vectors). Vectorized embedding information may include one or more contextual data embedding vectors. Each vectorized embedding information (e.g., contextual data embedded vector) may include a vector of values configured to identify semantic relationships between different contextual data via spatial relationships in a spatial domain. For example, each contextual data embedded vector may include semantic information corresponding to each user information. The contextual data including at least one of the textual data, audio data, and/or video data may be preprocessed (e.g., as described herein) for being input to the embedding model of the embedding module.

A second procedure may include converting the text version of (e.g., all) user information to the high dimensional embedding space. The image data may send the text data to the embedding model. The video captioning model may send the text data to the embedding model. The speech to text model may send the text data to the embedding model. The embedding model may generate (e.g., as described herein) vectorized embeddings, for example, based on the text data (e.g., converted by the image captioning model, converted by the video captioning model, converted by the speech to text model, and/or received by the embedding model). The embedding model may send the generated vectorized embeddings to the embedding datastore 514. The embedding(s) may be fed to the LLM model 506. The embedding(s) may be compatible with the embedding used by the LLM model 506. At the input of each LLM model (e.g., 506) there may be an embedding stage that converts the input text into a sequence of embedding vectors. The embedding layer(s) of the LLM model 506 may be used to convert the user information (e.g., converted to text format) into sequence(s) of embedding vectors. In other words, the embedding model in this case may be the embedding layers of the LLM model 506. At the input of each LLM (e.g., 506) there may be an embedding section made up of one or more layers. This part of the LLM 506 may convert a textual input into a set of vectorized embedding. Each embedding may represent one or more component(s). These sequences of embedding vectors (e.g., vectorized embeddings) may (e.g., then) be stored in the embedding datastore 504 (ED).

The embedding datastore 503 may store the vectorized embeddings (e.g., vectorized embedding information, contextual data embedded vectors) produced by the embedding model of the embedding module 502 for use in user generated queries. For example, the apparatus may store the vectorized embedding information (e.g., contextual data embedding vectors) in an embedded datastore. The ED 504 may provide the information mapping module (IM) with the mechanisms to query the datastore and/or return values of the embeddings. For example, the ED 504 may provide one or more mechanisms for the IM to determine the relevance score and/or the distance metric (e.g., distance between at least a portion of the decomposed embedded vector of the query and a contextualized data embedded vector). As described herein, the task(s) of calculating distance metric, comparing each distance metric with a threshold to find relevant vector(s) may be broken down between IM and ED in one or more different ways, which may be implementation specific. For example, the ED 504 may accept vector(s) from the IM and/or may calculate a score for each input vector and/or the stored vector pairs. This score may be proportional to the relevance and/or similarity of the stored vector to the input vector. Stored vectors with a high score may be used as additional context to augment the user query passed to the LLM 506. The ED 504 may provide the EM 502 with one or more mechanisms to write other embeddings into the datastore. Input data may be mapped to a common embedding vector space, where the magnitude of and/or angle of the input vector(s) may be found by calculating their semantic relevance against other stored embeddings and/or the related component(s). For example, input data may be mapped to a (e.g., common) embedding vector space; the magnitude of and/or angle of the embedding vector(s) are close (e.g., within a threshold distance) to that of other stored embedding vectors corresponding to similar component(s) and/or component(s). Similar component(s) may have embedding vectors that are closer (e.g., within a threshold distance) to each other while dissimilar component(s) may be further apart. One or more datastore management frameworks can be utilized for this purpose.

An apparatus may calculate (e.g., at an information mapping module), a relevance score for each independent component of the query to each vectorized embedding information (e.g., contextual data embedding vectors) in the embedded datastore. The information mapping module may calculate the relevance of the contextual information included in the ED with respect to the user query. The vectorized query embeddings may be matched against the contextual information stored in the ED. One or more metrics (e.g., cosine similarity, Euclidean distance) can determine the relevance of stored context information towards the user query.

This may allow the system to identify and/or extract relevant information to serve as context for the user query. For example, an apparatus may identify at least one of the vectorized embedding information (e.g., contextual data embedding vectors) above a threshold relevance score for being selected for input into a large language model (LLM).

One or more procedures are descried herein to find the most relevant embedding(s) from the datastore. To find the most relevant vectorized information from the datastore, a distance metric can be used together with a threshold value. For example, the MSE between the query vector(s) and the vectorized information in the datastore can be used as the distance metric. The smaller MSE in this case may represent closer vectors (e.g., within a threshold distance), which may mean more relevant vectors. One or more threshold value(s) can be used to select the relevant vector(s) from the datastore; the distance may be calculated between the query vectors and one or more vectorized embeddings in the datastore. The embeddings in the datastore corresponding to the distances that are less than the specified threshold value(s) may be selected. AS described herein, the IM may select one or contextual data embedded vectors that are less than a distance metric threshold and/or greater than a relevance score threshold. The threshold(s) (e.g., distance metric threshold, relevance score threshold) may be configured and/or may change based on requirement(s) to adjust the number of contextual data embedded vector(s) and/or how close they are to be to the query (e.g., within a threshold distance).

The value of the threshold can be selected based on how strict the selection of relevant embeddings from the datastore is. For example, larger values may result in more selected embeddings, which may influence the LLM response with less relevant user information.

Smaller values may result in more relevant responses and/or may result in missing additional relevant information. The threshold value may be a configurable value that may be adjusted by the end user.

One or more other distance metrics (e.g., cosine similarity) can be used. In other (e.g., more advanced) implementation(s), a neural network can be used to determine how close (e.g., relevant, within a threshold distance) a query is to one or more vectorized information units in the datastore.

An apparatus may receive a query from a wireless transmit/receive unit (WTRU). The query may include a textual and/or audio query for information in a response. For example, the query processing module (QPM) may take in a user query and/or may map it to a set of vectorized embeddings in the same semantic space as the EM. The QPM may (e.g., first) decompose the query into independent component(s), for example, by means of a (e.g., appropriate) learning model (e.g., RNNs for text, CNNs for images). The QPM may decompose the query into one or more independent components. The QPM may convert each independent component to an embedded vector. The IM may use each embedded vector to find relevant contextual information (e.g., as described herein, based on relevant contextual data embedded vectors). The IM may map the embedded vectors from the query to the relevant contextual vectors in the datastore. The may allow the system to measure the user query in terms of similarity with the contextual information stored in the ED.

The QPM may take as input the user query in text format and/or may output a set of vectorized embeddings. The vectorized embeddings may be compatible with the ones stored in the datastore. For example, the embedding layers of the LLM model can be used to create the vectorized embedding representing the user query. The QPM may operate similarly to the EM to generate the vectorized embeddings (e.g., as described herein). Since both the QPM and the EM may use the embedding layers of the LLM model, the generated vectorized embeddings may be compatible and/or can be compared with each other using a distance metric (e.g., as described herein, with respect to the information mapping module (IM)).

In one or more other implementations, a neural network model may be trained on a dataset of input queries and/or user information (with different modalities) to create embedding vectors. The same model can be used in QPM and/or EM module(s) to create compatible vectorized embeddings.

The large language model (LLM) may be responsible for local processing of user queries augmented by the contextual information identified by the IM. The context information can be appended as embeddings and/or as tokens in the input of the large language model. This may allow the LLM to benefit from personalized, contextual information that the system has collected to produce richer, more personalized outputs.

A large language model (e.g., ChatGPT, Gemini) may be made up of one or more of the following modules: tokenization, token embedding, positional embedding, transformer architecture with attention mechanism, and/or text generation. Embedding layers may refer to the layers responsible for tokenization and/or the token/positioning embedding layers.

A LLM may include tokenization. Tokenization may include the input information to be converted to data. The process of tokenization may include separating words and/or sub-words, and/or punctuations. The process of may include using a numerical value for each of the words, sub-words, and/or punctuations. Tokenization may include converting a sequence text string into a sequence of numbers. Each number in the output sequence may correspond to a token. The numbers may be looked up from a vocabulary lookup table.

A LLM may include token embedding. Token embedding may include the process of converting a sequence of tokens into a sequence of embedding vectors that represent a sentence in the input text.

A LLM may include positional embedding. Since the same word may mean different things depending on the context and/or where the word appears in the sentence, positional embedding may be used to differentiate between the meanings of the word in the given context.

A LLM may include transformer architecture with attention mechanism. This may include the processing part of the language model(s) and/or may be used in one or more LLMs.

A LLM may include text generation. At each portion of text generation, the LLM may predict the best word that may come next given the query, the context, and/or currently generated text up to the current portion. The text generation may include a classification mechanism where the model may pick the strongest word from the vocabulary of possible words.

In an example implementation, there may not be training and/or fine-tuning of the LLM. The embedding layers of an already trained LLM can be used (e.g., both) for QPM and/or EM module(s) to create compatible vectorized embeddings, for example, based on input text. In examples, the embeddings in the datastore may be compatible with the ones created by QPM at inference time. This may make the IM module as simple as calculating a distance metric and/or comparing the distance metric against a preconfigured threshold. Since the embeddings may be compatible, the selected vector(s) from the embedding datastore can be appended to the ones from the query at the input of LLM processing layers.

In one or more other implementations, different embedding models can be used. If the embeddings in the datastore are not compatible with the ones created by the LLM embedding layers, the Information Mapping Module (IM) may include a (e.g., trained) projection model (e.g., some kind of trained projection model) that can map the vectors from the datastore space to the one compatible with the LLM model. This model may be trained (e.g., as described herein) on a dataset with pairs of information in the two incompatible spaces. For example, the projection model can be trained using supervised learning. The model can be given the embedding from one distribution and predict the one from the other distribution. The difference between the predicted vector and the ground-truth (e.g., MSE between the vectors) can be used as the loss function to minimize the difference during the training.

In examples, the LLM model may be trained. For example, the LLM model may be retrained and/or fine-tuned to be compatible with the embeddings from the datastore. This approach may, additionally or alternatively, require a dataset of datastore embeddings together with input queries and/or the expected output response(s). The LLM may be trained (e.g., as described herein) on sample queries and/or vectorized embedding information (e.g., contextual data embedding vectors) identified as relevant to the requested query. For example, a dataset may be prepared that includes pairs of query information and/or their relevant embeddings from the datastore. This can be used in a supervised learning setting to train the LLM. The at least one vectorized embedding information (e.g., contextual data embedding vectors) above the threshold may be appended as embeddings and/or tokens to the query and/or portions thereof.

FIG. 6 depicts an example implementation where the embedding layers of the (pre)trained LLM may be used as the query processing model. The user query embeddings extracted from the user query text may be used to calculate distances with each element in the embedding datastore. The distances may be compared to a (pre)configured threshold and/or the embeddings that result in distances smaller than the threshold may be selected. The selected embeddings may be appended to the original query embeddings. The (e.g., next) layers of the LLM may generate the response, which may be based on (e.g., both) the user query and/or the relevant information from the datastore.

An apparatus may receive a query from a WTRU. For example, the QPM 602 may receive the user query. The query may include a textual and/or audio query for information in a response. The QPM 602 may include a query embedding model. For example, the apparatus may receive, at an embedding model, contextual data related to potential queries from a user for information at an embedding model. The contextual data may include at least one of a textual data, audio data, and/or video data. The embedding model may be trained to receive the contextual data and/or may generate different contextual data embedded vectors each including a vector of values configured to identify semantic and/or syntactic relationships between different contextual data via spatial relationships in a spatial domain.

The query embedding model may extract query embeddings (e.g., decompose the query) from the query text. For example, the apparatus may decompose the query into a set of vectorized embeddings. The set of vectorized embeddings may include the embedded vector.

The QPM 602 may send the query embeddings 604 (e.g., set of vectorized embeddings) to the IM 606.

The apparatus may identify at least one contextual data embedded vector that is relevant to at least one portion of an embedded vector associated with the query based on a criteria. For example, the IM 606 may calculate a distance metric associated with each query embedding 604 (e.g., as described herein). The IM 606 may compare each distance metric with a (pre)configured threshold. For example, an apparatus may identify at least one of the vectorized embedding information (e.g., contextual data embedding vectors) above a threshold relevance score for being selected for input into a large language model (LLM). The IM 606 may select one or more query embeddings based on the comparison of the calculated distance metric associated with each query embedding and the (pre)configured threshold. For example. The IM 606 may calculate a first distance metric associated with a first query embedding, a second distance metric associated with a second query embedding, and/or a third distance metric associated with a third query embedding. The IM 606 may determine that the first distance metric is less than a distance threshold. The IM 606 may determine that the second distance metric is greater than a distance threshold. The IM 606 may determine that the third distance metric is less than a distance threshold. The IM 606 may select the second query embedding for at least the reason the second distance metric is above the distance threshold. A smaller distance may represent a relevant score, and vice versa; the smaller the distance, the higher the score and more relevant the contextual data embedded vector is to the embedded vector(s) associated with the query. The IM 606 may send the selected embedding(s) from the datastore to the LLM model.

An apparatus may input the query and/or portions thereof, and/or the at least one vectorized embedding information (e.g., identified contextual data embedding vectors) based on the criteria (e.g., above the threshold) to the LLM. The LLM 608 may be trained on sample queries and/or contextual data embedded vectors identified as relevant to the requested query. The at least one contextual data embedded vector may be incorporated with the query based on the criteria. The at least one contextual data embedded vector incorporated with the query and/or portions of the query may include the at least one contextual data embedded vector appended as embeddings and/or tokens to the query and/or portions of the query based on the criteria. For example, the LLM model 608 may receive the user query (e.g., text). For example, one or more embedding layers at the LLM model 608 may receive the user query (e.g., as a first input). The embedding layers may generate query embedding vectors based on the user query. The LLM model 608 may receive the selected embeddings (e.g., from the datastore, as described herein, as a second input). The LLM model 608 may augment (e.g., as described herein) the query embedding vector(s) with the selected embeddings of user information. The LLM 608 may employ one or more processing layers (e.g., transformer layers). The LLM 608 may use the one or more processing layers to output a response (e.g., contextualized response) based on the embedded vector(s) associated with the query (e.g., first input) and/or the selected at least one contextual data embedded vector (e.g., second input). The apparatus may receive a contextualized response to the query from the LLM 608 based on the at least one contextual data embedded vector incorporated with the query, based on the criteria. The apparatus may transmit the contextualized response. For example, the apparatus may transmit the contextualized response via a (e.g., local, secure) network (e.g., as described herein) to the WTRU.

What is claimed is:

1. An apparatus comprising:
a processor configured to:
receive a query from a wireless transmit/receive unit (WTRU);
identify at least one contextual data embedded vector that is relevant to at least one portion of an embedded vector associated with the query based on a criteria;
input the query or portions of the query and the at least one contextual data embedded vector, based on the criteria, to a large language model (LLM), wherein the at least one contextual data embedded vector is incorporated with the query based on the criteria;
receive a contextualized response to the query from the LLM based on the at least one contextual data embedded vector incorporated with the query, based on the criteria; and
transmit the contextualized response via a network to the WTRU.

2. The apparatus of claim 1, wherein the at least one contextual data embedded vector incorporated with the query or portions of the query comprises the at least one contextual data embedded vector appended as embeddings or tokens to the query or portions of the query.

3. The apparatus of claim 2, wherein the LLM is trained on sample queries and contextual data embedded vectors identified as relevant to the received query.

4. The apparatus of claim 1, wherein the at least one contextual data embedded vector comprises a plurality of contextual data embedded vectors, and wherein the processor is configured to indicate spatial relationships of the plurality of contextual data embedded vectors via distances and angles.

5. The apparatus of claim 1, wherein the processor is further configured to receive, at an embedding model, contextual data related to potential queries from a user for information at an embedding model, the contextual data comprising at least one of textual data, audio data, or video data, wherein the embedding model is trained to receive the contextual data and generate different contextual data embedded vectors each comprising a vector of values configured to identify semantic relationships between different contextual data via spatial relationships in a spatial domain.

6. The apparatus of claim 1, wherein the processor is further configured to store the vectorized embedding information in an embedded datastore.

7. The apparatus of claim 1, wherein the processor is further configured to decompose, at a query processing module, the query into a set of vectorized embeddings, wherein the set of vectorized embeddings comprises the embedded vector, wherein the processor is configured to decompose the query into the set of embedded vectors such that each embedded vector comprised in the set of embedded vectors is compatible with each contextual data embedded vector.

8. The apparatus of claim 6, wherein the processor is further configured to calculate, at an information mapping module, relevance of each contextualized data embedded vector in the embedded datastore to each embedded vector or portions thereof of the query based on criteria to identify the at least one contextual data embedded vector that is relevant to the at least one portion of the embedded vector.

9. The apparatus of claim 8, wherein the criteria comprises a threshold and a relevance score, and wherein the processor is configured to determine the relevance of each contextual data embedded vector to the vectorized embeddings or portions thereof of the query based on whether the relevance score associated with each contextual data embedded vector is above the threshold, and wherein the at least one contextual data embedded vector is appended as embeddings or tokens to the query or portions thereof when the relevance score associated with the at least one contextual embedded vector is above the threshold.

10. The apparatus of claim 9, wherein the relevance score is determined based on a distance between a vectorized embedding of the query or portions thereof and a contextualized data embedded vector of the at least one contextual data embedded vector.

11. The apparatus of claim 10, wherein, when the relevance score of a contextual data embedded vector is above the threshold, the processor is configured to select the at least one contextual data embedded vector to incorporate with the query for input into the LLM.

12. The apparatus of claim 11, wherein the processor is configured to use a top K-filter to select a subset of contextual data embedded vectors, from the at least one contextual embedded vector, to incorporate with the query for input into the LLM.

13. A method performed by an apparatus, the method comprising: receiving a query from a wireless transmit/receive unit (WTRU);
identifying at least one contextual data embedded vector that is relevant to at least one portion of an embedded vector associated with the query based on a criteria;
inputting the query or portions of the query and the at least one contextual data embedded vector, based on the criteria, to a large language model (LLM), wherein the at least one contextual data embedded vector is incorporated with the query based on the criteria;
receiving a contextualized response to the query from the LLM based on the at least one contextual data embedded vector incorporated with the query, based on the criteria; and
transmitting the contextualized response via a network to the WTRU.

14. The method of claim 13, wherein the at least one contextual data embedded vector incorporated with the query or portions of the query comprises the at least one contextual data embedded vector appended as embeddings or tokens to the query or portions of the query.

15. The method of claim 14, wherein the LLM is trained on sample queries and contextual data embedded vectors identified as relevant to the received query.

16. The method of claim 13, wherein the at least one contextual data embedded vector comprises a plurality of contextual data embedded vectors, and wherein the method comprises indicating spatial relationships of the plurality of contextual data embedded vectors via distances and angles.

17. The method of claim 13, further comprising receiving, at an embedding model, contextual data related to potential queries from a user for information at an embedding model, the contextual data comprising at least one of textual data, audio data, or video data, wherein the embedding model is trained to receive the contextual data and generate different contextual data embedded vectors each comprising a vector of values configured to identify semantic relationships between different contextual data via spatial relationships in a spatial domain.

18. The method of claim 13, further comprising storing the vectorized embedding information in an embedded datastore.

19. The method of claim 13, further comprising decomposing, at a query processing module, the query into a set of vectorized embeddings, wherein the set of vectorized embeddings comprises the embedded vector, wherein the set of the set of embedded vectors are decomposed such that each embedded vector comprised in the set of embedded vectors is compatible with each contextual data embedded vector.

20. The method of claim 18, further comprising calculating, at an information mapping module, relevance of each contextualized data embedded vector in the embedded datastore to each embedded vector or portions thereof of the query based on criteria to identify the at least one contextual data embedded vector that is relevant to the at least one portion of the embedded vector.

21. The method of claim 20, wherein the criteria comprises a threshold and a relevance score, and wherein the method further comprising determining the relevance of each contextual data embedded vector to the vectorized embeddings or portions thereof of the query based on whether the relevance score associated with each contextual data embedded vector is above the threshold, and wherein the at least one contextual data embedded vector is appended as embeddings or tokens to the query or portions thereof when the relevance score associated with the at least one contextual embedded vector is above the threshold.

22. The method of claim 21, wherein the relevance score is determined based on a distance between a vectorized embedding of the query or portions thereof and a contextualized data embedded vector of the at least one contextual data embedded vector.

23. The method of claim 22, wherein, when the relevance score of a contextual data embedded vector is above the threshold, the method further comprising selecting the contextual data embedded vector to append to the query or portions for input into the LLM.

24. The method of claim 23, wherein the at least one contextual data embedded vector is selected based on a Top-K filter to select a subset of contextual data embedded vectors, wherein the subset of contextual data embedded vectors are incorporated with the query for input into the LLM.
